(19) United States
(12) Patent Application Publication
(10) Pub. No.: US 2009/0068416 A1
(43) Pub. Date: Mar. 12, 2009

(54) Process for Coating a Substrate with a Coating Precursor Forming a Coating as a Product of Ester Condensation and Products Coated with Such Coating Precursor

(76) Inventors: Isao Noda, Fairfield, OH (US); William Maxwell Allen, JR., Liberty Twp., OH (US); Michael Matthew Satkowski, Oxford, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/961,488

(22) Filed: Dec. 20, 2007

Related U.S. Application Data
(60) Provisional application No. 60/993,440, filed on Sep. 12, 2007.

(51) Int. Cl. B32B 27/06; B32B 27/36; C08G 77/00; C08G 63/48; B05D 3/10

(52) U.S. Cl. 428/195.1; 427/385.5; 427/387; 427/389.7; 427/391; 427/389.9; 528/295.5; 528/26.5; 428/431; 428/480

(57) ABSTRACT

A process is provided for coating a surface of a substrate using a coating precursor comprising a reactive mixture which is reacted to form a coating as a product of ester condensation. The reactive mixture includes a monomer mixture comprising at least one polyhydric alcohol and a reactant selected from the group consisting of at least one organic polyacid; at least one organic anhydride; and combinations thereof. Alternatively, the reactive mixture comprises a prepolymer formed from the monomer mixture; a combination of the prepolymer and the monomer mixture; or a combination of the prepolymer and reactants such as polyhydric alcohol, organic polyacid, organic anhydride, and combinations thereof.

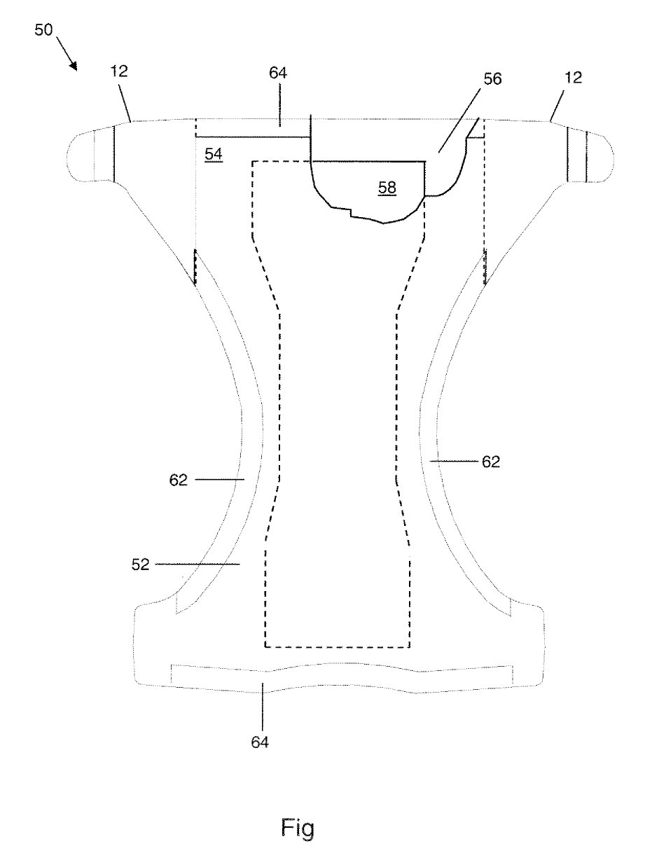

### CROSS REFERENCE TO RELATED APPLICATION

This application claims the benefit of provisional Application No. 60/993,440, filed Sep. 12, 2007.

### FIELD OF THE INVENTION

The present invention is directed to a reactive mixture comprising either a monomer mixture or reactive prepolymer capable of making crosslinked thermoset resins, particularly alkyd resins, formulated to form a coating on the surface of a substrate. In a specific embodiment, the reactive mixture provides a coating precursor which is applied to the surface of a substrate and reacted to form solid coating as a product of ester condensation.

### BACKGROUND OF THE INVENTION

Coatings are used in many applications for protecting and enhancing properties of materials. For instance, the properties of lignocellulosic materials, such as paper, linerboard, corrugated medium, carton board and paper structures in general can be altered by adding coatings to increase the strength or add properties such as water proofing. Coatings are also added to surfaces of glass, wood and metals to enhance strength and provide protection. In addition, thin substrates, such as films, paper sheets, and nonwoven fabrics, can be covered with spatially distributed coating materials instead of uniform coating to provide localized or directional mechanical properties, such as bending or stretching. Coatings are typically viscous and tacky requiring special care during application and making the material to which they are applied difficult to handle during processing.

Alkyd is a term applied to a group of synthetic thermoset resins best described as polyester condensate resins. This group of material comprises ester condensates of polyhydric alcohols and organic polyacids. Glycerin is the predominant polyhydric alcohol component used in ester condensates. An increasing supply of glycerin has prompted the opportunity for developing applications utilizing alkyd resins.

Alkyds possess many desirable properties required of a protective coating. Alkyd resins start as a low viscosity liquid reactive mixture comprising either a monomer mixture or reactive prepolymer mixture which can be formulated in a free flowing liquid state which is easy to apply. Such monomer or prepolymer reactive mixture can be cured by a crosslinking chemical reaction typically induced by the application of heat to form a viscous or hard material. As a result, the alkyd can be applied to a substrate in a liquid monomer or prepolymer form and subsequently heated to form a solid coating.

The need exist for a process for coating substrates with liquid monomer or prepolymer reactive mixtures that polymerize or react forming a coating as a product of ester condensation subsequent to application.

### SUMMARY OF THE INVENTION

The present invention provides a process for coating a surface of a substrate with a coating precursor which is reacted to form a solid coating as a product of ester condensation. The coating precursor includes a reactive mixture comprising a monomer mixture having at least one polyhydric alcohol and a reactant selected from the group consisting of at least one organic polyacid; at least one organic anhydride; and combinations thereof. Alternatively, the reactive mixture comprises a prepolymer formed from the monomer mixture; a combination of the prepolymer and the monomer mixture; or a combination of the prepolymer and reactants such as polyhydric alcohol, organic polyacid, organic anhydride, and combinations thereof.

The invention is also directed to a composite structure comprising a substrate and a coating precursor deposited of the surface of the substrate which is reacted to form a coating as a product of ester condensation. The coating precursor comprises a reactive mixture including a monomer mixture comprising at least one polyhydric alcohol and a reactant selected from the group consisting of at least one organic polyacid; at least one organic anhydride; and combinations thereof. Alternatively, the reactive mixture comprises a prepolymer formed from the monomer mixture; a combination of the prepolymer and the monomer mixture; or a combination of the prepolymer and reactants such as polyhydric alcohol, organic polyacid, organic anhydride, and combinations thereof.

The invention is further directed to a composite structure and process of forming a composite structure comprising a substrate and the aforementioned coating precursor deposited at select locations on the surface of the substrate which is reacted to form a solid coating providing selective reinforcement of the substrate. For this embodiment, the coating precursor can be printed on the surface of a substrate in a pattern which solidifies forming an integral part of the substrate and a corresponding composite structure having added mechanical integrity.

### DETAILED DESCRIPTION OF THE INVENTION

All percentages, ratios and proportions used herein are by weight percent of the reactive mixture, unless otherwise specified. All average values are calculated “by weight” of the reactive mixture or components thereof, unless otherwise expressly indicated. “Average molecular weight,” or “molecular weight” for polymers, unless otherwise indicated, refers to weight average molecular weight. Weight average molecular weight, unless otherwise specified, is determined by gel permeation chromatography.

“Copolymer” as used herein is meant to encompass copolymers, terpolymers, and other multiple-monomer polymers.

“Reactant” as used herein refers to a chemical substance that is present at the start of a chemical reaction and reacts with one or more other substances or catalysts in or exposed as part of a chemical reaction.

“Mixture” as used herein refers to a mixture of two or more of any of a defined group of components, unless otherwise specified. Lists of alternative ingredients include mixtures of such ingredients unless otherwise specified.

“Biodegradable” as used herein refers to the ability of a compound to ultimately be degraded completely into CH₄, CO₂ and water or biomass by microorganisms and/or natural environmental factors.

“Compostable” as used herein refers to a material that meets the following three requirements: (1) the material is capable of being processed in a composting facility for solid waste; (2) if so processed, the material will end up in the final compost; and (3) if the compost is used in the soil, the material will ultimately biodegrade in the soil.

“Comprising” as used herein means that various components, ingredients or steps can be conjointly employed in practicing the present invention. Accordingly, the term “comprising” encompasses the more restrictive terms “consisting essentially of” and “consisting of”. The present reactive compositions can comprise, consist essentially of, or consist of any of the required and optional elements disclosed herein.

Markush language as used herein encompasses combinations of the individual Markush group members, unless otherwise indicated.

The terms “water-permeable” and “water-impermeable” refer to the penetrability of materials in the context of the intended usage of disposable absorbent articles. Specifically, the term “water-permeable” refers to a layer or a layered structure having pores, openings, and/or interconnected void spaces that permit liquid water to pass through its thickness in the absence of a forcing pressure. Conversely, the term “water-impermeable” refers to a layer or a layered structure through the thickness of which liquid water cannot pass in the absence of a forcing pressure. A layer or a layered structure that is water-impermeable according to this definition may be permeable to water vapor, i.e., may be “water vapor-permeable”. Such a water vapor-permeable layer or layered structure is commonly known in the art as “breathable”. As is well known in the art, a common method for measuring the permeability to water of the materials typically used in absorbent articles is a hydrostatic pressure test, also called a hydrostatic head test or simply a “hydrohead” test. Suitable well known compendial methods for hydrohead testing are approved by INDA (formerly the International Nonwovens and Disposables Association, now The Association of the Nonwoven Fabrics Industry) and EDANA (European Disposables And Nonwovens Association).

Regarding all numerical ranges disclosed herein, it should be understood that every maximum numerical limitation given throughout this specification includes every lower numerical limitation, as if such lower numerical limitations were expressly written herein. In addition, every minimum numerical limitation given throughout this specification will include every higher numerical limitation, as if such higher numerical limitations were expressly written herein. Further, every numerical range given throughout this specification will include every narrower numerical range that falls within such broader numerical range and will also encompass each individual number within the numerical range, as if such narrower numerical ranges and individual numbers were all expressly written herein.

The present processes and articles employ coating comprising a reactive mixture capable of making crosslinked thermoset resins, particularly alkyd resins, from an ester condensation reaction. The reactive mixture comprises a monomer mixture including polyhydric alcohol and a polyfunctional organic polyacid or anhydride. The reactive mixture can also include a prepolymer made by reacting the monomer mixture to a precrosslinking stage, or a combination of the prepolymer and the monomer. The reactive mixture is formulated to be easily applied to a substrate surface as a free flowing liquid coating precursor which can be reacted to form a coating. During the reaction, the coating precursor can be heated to an elevated temperature sufficient to induce an ester condensation reaction of the reactive mixture which polymerizes and crosslinks the mixture by liberating water as a reaction byproduct to open atmosphere resulting in a solid coating material.

The materials used in forming the aforementioned coating precursor, methods of making the same and composite structures formed utilizing the coating precursor are further discussed below.

### Polyhydric Alcohol

The reactive mixture used in forming the coating precursor includes polyhydric alcohol. “Polyhydric alcohol” as used herein refers to an alcohol having two or more alcohol (i.e., hydroxyl) functional groups. Any suitable polyhydric alcohol or combination of polyhydric alcohols is of use; however, monomers, oligomers, or short chain polymer polyhydric alcohols having a molecular weight of less than 2000 g/mol are preferred. Non-limiting examples of suitable polyhydric alcohols include: glycerol (also known in the art as glycerin), glycol, sugar, sugar alcohol, and combinations thereof. Non-limiting examples of glycols of use include: ethylene glycol, propylene glycol, dipropylene glycol, butylene glycol, hexane triol, and the like, oligomers thereof, and combinations thereof. Non-limiting examples of sugars of use include: glucose, sucrose, fructose, raffinose, maltodextrose, galactose, xylose, maltose, lactose, mannose, erythrose, pentaerythritol, and mixtures thereof. Non-limiting examples of sugar alcohols of use include: erythritol, xylitol, malitol, mannitol, sorbitol, and mixtures thereof. In specific embodiments of the present invention, the polyhydric alcohol comprises glycerol, mannitol, sorbitol, and combinations thereof.

Another form of polyhydric alcohol suitable in forming the reactive mixture includes crude glycerin. Crude glycerin is derived from various reactions of a triglyceride which is basically glycerin and three fatty acids linked together by ester bonds. Reactions which generate crude glycerin include esterification, hydrolysis, and saponification. Crude glycerin is typically 80-95% glycerin and contains some level of water (moisture), typically 3-15%, based on the chemistry and recovery process. Crude glycerin will also contain some level of non-glycerin organics, quantified as total fatty acid. These are typically unreacted triglycerides (or diglycerides/monoglycerides), fatty acids, and methyl esters.

Typically, the polyhydric alcohol can be present in reactive mixtures of the present invention in an amount of from about 5% to about 80%, from about 10% to about 75%, from about 25% to about 70%, or from about 35% to about 65%.

### Organic Polyacid and Anhydrides

The reactive mixture used in forming the coating precursor includes organic polyacids and anhydrides. The organic polyacid means an organic acid having two or more acid functionalities and can include, but is not limited to, diacids, triacids (having at least three acid groups), other acids with four or more acid functionalities, acid polymers or copolymers, or mixtures thereof. Such acids include, but are not limited to adipic acid, sebatic acid, citric acid, oxalic acid, malonic acid, succinic acid, glutaric acid, maleic acid, fumaric acid, phthalic acid, isophthalic acid, terphthalic acid, and mixtures of two or more thereof. Anhydrides of such acids may also be employed and within the context of the present specification, reference to organic polyacid includes such anhydrides. Monoacids such as lauric acid, stearic acid, miristic acid, palmitic acid, oleic acid, linoleic acid, sebacic acid, acrylic acid, methacrylic acid, itaconic acid, and glycidyl methacrylate may optionally be included in addition to polyacids at any stage. For example, monoacids may be added as processing aids or to modify properties of the final product, e.g. flexibility, strength, etc.

For the present invention many different types of organic polyacids and anhydrides can be used including adipic acid, citric acid, maleic acid, maleic anhydride, polyacrylic acid, phthalic anhydride, and the like, as well as their mixtures. Monobasic acids, especially fatty acids like stearic acid, lauric acid, oleic acid, and linoleic acid, can also be incorporated into the reactive mixture. Other functional compounds with reactive acid or alcohol functionality, such as oligomeric silicone or polyethylene glycol, may also be incorporated.

Typically, the organic polyacid or anhydride is employed in the reactive mixtures of the present invention in an amount of from about 5% to about 80%, from about 10% to about 75%, from about 25% to about 70%, or from about 35% to about 65%.

### Triglyceride

Any suitable triglycerides, which are also known in the art as triacylglycerols, may also be included in the reactive mixture. Non-limiting examples of triglycerides of use include: tristearin, triolein, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, trilinolein, 1,2-dipalmitolinolein, 1-palmito-dilinolein, 1-stearo-dilinolein, 1,2-diacetopalmitin, 1,2-distearo-olein, 1,3-distearo-olein, trimyristin, trilaurin and combinations thereof.

Suitable triglycerides may be added to the present reactive compositions in neat form. Additionally, or alternatively, oils and/or processed oils containing suitable triglycerides may be added to the reactive compositions. Non-limiting examples of oils include coconut oil, corn germ oil, olive oil, palm seed oil, cottonseed oil, palm oil, rapeseed oil, sunflower oil, whale oil, soybean oil, peanut oil, linseed oil, tall oil, and combinations thereof.

Typically, triglycerides are employed in the reactive mixture in an amount up to about 75%, or from about 2% to about 50%, or from about 5% to about 25%.

In some embodiments, combinations of acid and triglyceride are employed in the reactive mixture. In such embodiments, the total amounts of acid and triglyceride is from about 20% to about 80%, from about 30% to about 70%, or from about 40% to about 60%. Additionally, or alternatively, the molar ratio of the alcohol functional groups to the total of ester and acid functional groups is at least about 1:1, or at least about 4:1. In some embodiments, the molar ratio is from about 1:1 to about 200:1, or from about 1:1 to about 50:1.

The reactive mixture of the present invention may also include monobasic acid, and appropriate amounts of monoglyceride, or diglyceride as alternatives to triglyceride.

### Additional Components

The reactive mixtures used in forming the coating precursor may further include one or more additional components as desired for the processing and/or end use of the composition. Additional components may be present in any suitable amount. In some embodiments, additional components may be present in an amount of from about 0.01% to about 35% or from about 2% to about 20% by weight of the reactive mixture. Non-limiting examples of additional components include, but are not limited to, additional polymers, processing aids and the like.

Non-limiting examples of additional polymers of use include: polyhydroxyalkanoates, polyethylene, polypropylene, polyethylene terephthalate, maleated polyethylene, maleated polypropylene, polylactic acid, modified polypropylene, nylon, caprolactone, and combinations thereof. Additional polymers also include polyvinyl alcohol and polyhydric alcohols having molecular weights of greater than 2000 g/mol.

In embodiments in which properties including, but not limited to, biodegradability and/or flushability are desired, additional suitable biodegradable polymers and combinations thereof are of use. In some embodiments, polyesters containing aliphatic components are suitable biodegradable thermoplastic polymers. In some embodiments, among the polyesters, ester polycondensates containing aliphatic constituents and poly(hydroxycarboxylic acid) are preferred. The ester polycondensates include, but are not limited to: diacids/diol aliphatic polyesters such as polybutylene succinate, and polybutylene succinate co-adipate; aliphatic/aromatic polyesters such as terpolymers made of butylenes diol, adipic acid, and terephthalic acid. The poly(hydroxycarboxylic acids) include, but are not limited to: lactic acid based homopolymers and copolymers; polyhydroxybutyrate; and other polyhydroxyalkanoate homopolymers and copolymers. In some embodiments, a homopolymer or copolymer of poly lactic acid is preferred. Modified polylactic acid and different stereo configurations thereof may also be used. Suitable polylactic acids typically have a molecular weight range of from about 4,000 g/mol to about 400,000 g/mol. Examples of suitable commercially available poly lactic acids include NATUREWORKS™ from Cargill Dow and LACEA™ from Mitsui Chemical. An example of a suitable commercially available diacid/diol aliphatic polyester is the polybutylene succinate/adipate copolymers sold as BIONOLLE™ 1000 and BIONOLLE™ 3000 from the Showa Highpolmer Company, Ltd. Located in Tokyo, Japan. An example of a suitable commercially available aliphatic/aromatic copolyester is the poly(tetramethylene adipate-co-terephthalate) sold as EASTAR BIO™ Copolyester from Eastman Chemical or ECOFLEX™ from BASF. In some embodiments, the biodegradable polymer or combination of polymers may comprise polyvinyl alcohol.

The aforementioned biodegradable polymers and combinations thereof may be present in an amount of from about 0.1% to about 70%, from about 1% to about 50%, or from about 2% to about 25%, by weight of the reactive mixture.

Processing aids are generally present in the reactive mixture in amounts of from about 0.1% to about 3% or from about 0.2% to about 2% by weight of the reactive mixture. Non-limiting examples of processing aids include: lubricants, anti-tack, polymers, surfactants, oils, slip agents, and combinations thereof. Non-limiting examples of specific processing aids include: Magnesium stearate; fatty acid amides; metal salts of fatty acids; wax acid esters and their soaps; montan wax acids, esters and their soaps; polyolefin waxes; non polar polyolefin waxes; natural and synthetic paraffin waxes; fluoro polymers; and silicon. Commercial examples of such compounds include, but are not limited to: Crodamide™ (Croda, North Humberside, UK), Atmer™ (Uniqema, Everberg, Belgium,) and Epostan™ (Nippon Shokobai, Tokyo, JP).

Other additives can be present in the reactive mixture to impart additional physical properties to the final product or material formed therefrom. Such additives include compounds having functional groups such as acid groups, alcohol groups and combinations thereof Such compounds include oligomeric silicone, polyethylene glycol and combinations thereof

### Fillers

The fillers can be mixed with the reactive mixture providing the coating precursor. Fillers comprise solid particulates having an equivalent diameter of less than 300 microns, less than 100 microns or less than 50 microns. Non-limiting examples of fillers present in the reactive mixture of the present invention include: talc, clay, pulp, wood, flour, walnut shells, cellulose, cotton, jute, raffia, rice chaff, animal bristles, chitin, TiO₂, thermoplastic starch, raw starch, granular starch, diatomaceous earth, nanoparticles, carbon fibers, kenaf, silica, inorganic glass, inorganic salts, pulverized plasticizer, pulverized rubber, polymeric resins and combinations thereof. Further additives including inorganic fillers such as the oxides of magnesium, aluminum, silicon, and titanium may also be added as inexpensive fillers or processing aides. Other inorganic materials include hydrous magnesium silicate, titanium dioxide, calcium carbonate, boron nitride, limestone, mica glass quartz, and ceramics. Additionally, inorganic salts, including alkali metal salts, alkaline earth metal salts, phosphate salts, may be used as processing aides. Another material that can be added is a chemical composition formulated to further accelerate the environmental degradation process such as cobalt stearate, citric acid, calcium oxide, and other chemical compositions found in U.S. Pat. No. 5,854,304 to Garcia et al.

The aforementioned fillers and combinations thereof may be present in the reactive mixture forming the coating precursor in an amount up to about 40% by weight of the reactive mixture; from about 1% to about 30%, 2% to about 20%, and 5% to about 10%, by weight of the reactive mixture.

### Ester Condensation Reaction

As previously described herein, coatings comprising an alkyd resin are made from the condensation reaction of a reactive mixture comprising monomers, such as polyhydric alcohol and a polyfunctional organic polyacid, or from an oligomer which is a prepolymer made by reacting the monomer mixture to a precrosslinking stage where condensation reaction has already at least partially, but not completely taken place between the polyhydric alcohol and the acid. During the condensation reaction, if the temperature of the reactive mixture is sufficiently high and for a sufficient time to drive a reaction between the polyhydric alcohol and the acid, the composition which is formed will convert to a water stable alkyd resin composition. For example, the reactive mixture can be processed providing sufficient removal of water for conversion to a water stable composition. In such an embodiment, the composition can be processed to a form which is suitable for end use such as a solid coating formed on the surface of a substrate.

On the other hand, if the temperature or conditions at which the melt processing of the reactive mixture is conducted is sufficiently low and/or for an insufficient time to drive reaction between the polyhydric alcohol and the acid, the resulting composition comprises a reactive mixture, which may be further processed, if desired, and which is convertible to water stable compositions by further heating. The reactive mixture can therefore be provided in this embodiment in a liquid form which can be applied to a surface of a substrate in the form of a coating precursor which can be subjected to sufficient conditions of temperature and time to effect the conversion of the reactive mixture to a water stable coating composition. Alternatively, if the coating precursor is not subjected to sufficient conditions of temperature and time to effect the conversion of the reactive composition, the resulting reactive mixture can be subsequently heated and converted to a water stable coating composition.

### Coating Precursor Application

Any suitable applicator may be used to apply the coating precursor to a material or substrate such as: a printing station (such as rotogravure or flexographic for example), a spraying station,), a coater station (such as slot, roll, or air knife for example), a size press station, or a foam applicator station. A suitable apparatus for applying the coating precursor is disclosed in U.S. Pat. No. 5,840,403 issued to Trokhan et al. on Nov. 24, 1998, and herein incorporated by reference.

Any known printing technique can be used to apply the coating precursor including gravure printing, offset printing, flexographic printing, slot coating, ink jet printing (e.g., thermal drop on demand ink jets, piezoelectric drop on demand ink jets, continuous ink jets, etc.), and other forms of digital printing including electrostatic printing and electrophotography, such as the CreoScitex SP system of CreoScitex (Tel Aviv, Israel). Other exemplary printer systems include the Vutek UltraVu printers (Vutek, Meredith, N.H.) as examples of high resolution, wide ink jet printers (2 meters, for example); the DisplayMaker FabriJet XII 12-cartridge printer of ColorSpan Corp. (Eden Prairie, Minn.), and the wide ink-jet printing Artistri system of DuPont (Wilmington, Del.). Printing techniques conventionally used for applying inks can generally be adapted to apply coating precursors with or without added color. For example, principles of adapting flexographic printing for the application of coating precursors to tissue and other fibrous webs has been disclosed in U.S. application Ser. No. 10/329,991, “Flexographic Printing to Deliver Highly Viscous Agents in a Pattern to the Skin-Contacting Surface of an Absorbent Article,” filed Dec. 26, 2002, by Chen and Lindsay, and in U.S. application Ser. No. 10/305791, “Structural Printing of Absorbent Webs,” filed Nov. 27, 2002, by Chen et al., both of which are herein incorporated by reference. Anilox rolls for application of printed adhesive to one or both sides of a tissue web are disclosed in U.S. Pat. No. 6,607,630, “Print Bonded Multi-Ply Tissue,” issued Aug. 19, 2003, to Bartman et al., which can be adapted for printing single or multi-ply webs.

Any known spray technology can be used to apply the coating precursor, including DRYAD spray technology by Dryad Technology, Delaware, as described by R. H. Donnelly and M. Kangas, Paperi ja Puu, Vol. 83, No. 7, pp. 530-531. Another embodiment is disclosed in U.S. Pat. No. 4,944,960, “Method and Apparatus for Coating Paper and the Like,” issued Jul. 31, 1990 to Sundholm et al. In this technology, the coating precursor passes into a nozzle that ejects the material to a region with an annular high-velocity gas flow around it that carries the precursor material to the surface of substrate. Electrostatic charge can be used to improve delivery of the coating precursor to the substrate. Printing of the coating precursor can be done selectively or uniformly to a surface of a substrate.

The coating precursor can be applied in any desirable pattern such as fine lines, dots, crossing lines, sinuous lines, patterns that form recognizable images such as those of flowers or other patterns. In various embodiments of the invention, the coating precursor occupies from about 15% to about 60% of the surface area of one side of a substrate. Alternatively, the coating precursor may occupy any of the following percentage ranges of one side of a substrate: about 5% or more, about 30% or more, over 50%, from about 10% to about 90%, from about 20% to about 80%, from about 20% to about 70%, less than about 60%, and less than 50%.

### Coating Precursor Post Curing

When the coating precursor formed from the reactive mixture is applied to a surface of a substrate to be coated, the crosslinking reaction can be completed either during the application of the coating precursor or by an additional post curing step. In order to produce fully crosslinked coating from the coating precursor, the ester condensation reaction of the reactive mixture is induced, and/or driven towards completion through the application of heat. Water produced as a reaction byproduct is effectively removed to promote the reaction. The reaction mixture temperature may be between about 100° C. and about 300° C., between about 120° C. and about 280° C., or between about 150° C. and about 260° C. to drive the crosslinking reaction to completion. In some embodiments of the present invention, a catalyst may be used to initiate and/or accelerate the ester condensation and/or transesterification reactions. Any suitable catalyst is of use. Non-limiting examples of useful catalysts include Lewis acids. A non-limiting example of a Lewis acid is para-toluene sulfonic acid.

Completing the crosslinking reaction via post curing can be accomplished in a conventional convective or radiant oven or microwave oven, as well as other means to heat the coating precursor during the post curing step to complete the ester condensation reaction and corresponding final removal of water therefrom.

### Articles

As used herein, “article” is meant to encompass articles having at least one portion coated utilizing a coating precursor according to the present invention. Articles include, but are not limited to adult incontinence products, feminine hygiene pads and sanitary napkins, disposable diapers and training pants.

### Selective Reinforcement

The low viscosity of monomer mixtures and prepolymers of the present invention enables the utilization of simple printing technology to deliver the coating precursor to the surface of a substrate in a specific pattern, instead of a uniform coating as applied in the production of a conventional laminate film. The printed pattern is cured becoming an integral part of the composite structure with added mechanical integrity. The process resembles the spatially resolved printing of adhesives widely practiced in the industry. The difference is that, by choosing a reasonably strong reinforcing material, the printed pattern itself now serves as a source of additional mechanical strength. Depending on the specific design of the printed pattern, the composite material as a whole will have a variety of anisotropy and localized heterogeneity in mechanical properties. Thus, composites can be formed that can stretch in one direction but not in the other. In addition, some patterns can serve as folding lines in a manner similar to a set of creases. For instance, reinforcing material can be distributed on the surface of a substrate in a prescribed manner to prevent select portions from easily deforming under stress so that bending and folding can take place according to the distribution of reinforcing material. The process can provide a versatile means to design a three-dimensional shape of the final product by imposing the prescribed ease of bending, folding, and stretching projected from the two-dimensional pattern of reinforcement printed onto the surface of a substrate.

A typical alkyd resin monomer or prepolymer that is heated to a slightly elevated temperature has a very low liquid-like viscosity compared to conventional molten plastics or adhesives. This low viscosity provides a distinct advantage in the preparation of surface composites using alkyd resins. Such monomer or prepolymer can be deposited onto a variety of surfaces using conventional printing techniques. The low viscosity of a hot alkyd prepolymer similar to that of printing ink enables the capability of creating rather intricate fine patterns of alkyd on top of the substrate surface which is not readily achievable with high viscosity polymer melts.

The substrate can be a film, sheet, nonwoven fabrics, paper, laminate, or even another composite material. The printing can take place on either one or both sides of the substrate. Different reinforcing materials can be printed simultaneously or sequentially onto the same surface. In addition to the mechanical reinforcement effect, the printed patterns can be made visible to produce images, to achieve the more conventional intent of pattern printing.

### EXAMPLES

### Example 1

### Preparation of Glycerol-Maleate Oligomer

One mole of glycerol and 0.50% by weight of methanesulfonic acid catalyst are added to a beaker. These materials are stirred and warmed together rapidly in the beaker forming a clear solution. Next, 1 mole maleic anhydride is weighed out and added to the glycerol solution. The mixture is heated and stirred continuously while monitoring temperature and viscosity. The temperature is slowly raised so as to not to overheat since the initial reaction is exothermic. The mixture clears around 70-80° C. forming a clear, slightly straw-colored solution. The temperature of the solution is adjusted to approximately 140° C. Some bubbling will be noticeable at this time and should come to a moderate rate within a couple minutes. The solution is continuously heated and stirred at this temperature until a desired viscosity of 1-5 Poise is reached, which takes 10-30 minutes. The material should pour easily within the viscosity range noted and will be clear and straw-colored.

### Example 2

### Preparation of Glycerol-Maleate Oligomer with p-Toluenesulfonic Acid

One mole of glycerol and 0.50%, by weight of starting materials, p-toluenesulfonic acid as a catalyst, are added to a beaker. These materials are stirred and warmed together rapidly forming a clear solution. Next, 1 mole maleic anhydride is weighed out and added to the glycerol solution. The mixture is continuously heated and stirred while monitoring temperature and viscosity. The temperature is slowly raised so as to not to overheat since the initial reaction is exothermic. The mixture clears around 70-80° C. forming a clear, slightly straw-colored solution. The temperature of the solution is adjusted to approximately 140° C. Some bubbling will be noticeable at this time and should come to a moderate rate within a couple minutes. The solution is continuously heated and stirred at this temperature until a desired viscosity of 1-5 Poise is reached, which takes 10-30 minutes. The material should pour easily within the viscosity range noted and will be clear and straw-colored.

### Example 3

### Large Scale Preparation of Glycerol-Maleate Oligomer

One hundred (100) moles glycerol and 0.50%, by weight of starting materials, methanesulfonic acid as a catalyst, are added to a reactor. The materials are stirred and warmed together rapidly in the reactor forming a clear solution. Next, 100 moles maleic anhydride are weighed out and added to the glycerol solution in the reactor. This addition can be simplified by first liquefying the maleic anhydride in a beaker set at a temperature which is greater than 60° C., and then transferring this liquid to the reactor. The mixture is continuously heated and stirred while monitoring temperature and viscosity. The temperature is slowly raised so as to not to overheat since the initial reaction is exothermic. The mixture clears around 70-80° C. forming a clear, slightly straw-colored solution. The temperature of the solution is adjusted to approximately 140° C. Some bubbling will be noticeable at this time and should come to a moderate rate within a couple minutes. The solution is continuously heated and stirred at this temperature until a desired viscosity of 1-5 Poise is reached which takes 10-30 minutes. The material should pour easily within the viscosity range noted and will be clear and straw-colored.

### Example 4

### Preparation of Glycerol-Citrate Oligomer

One mole of glycerol and 0.50%, by weight of starting materials, methanesulfonic acid as a catalyst, are added to a beaker. The materials are stirred and warmed together rapidly forming a clear solution. Next, 1 mole citric acid is weighed out and added to the glycerol solution. The mixture is continuously heated and stirred while monitoring temperature and viscosity. The temperature is raised slowly so as to not to overheat. The mixture clears around 110-120° C. forming a clear, slightly yellow-colored solution. Some bubbling is noticeable in the 120-130° C. range. The temperature of the solution is adjusted to 135-140° C. The solution will be bubbling rapidly in this temperature range. The solution is continuously heated and stirred in this temperature range until a desired viscosity of 1-5 Poise is reached which takes 10-30 minutes. The material should pour easily within the viscosity range noted and will be clear and yellow-colored.

### Example 5

### Preparation of Glycerol-Succinate Oligomer

One mole glycerol and 0.50%, by weight of starting materials, methanesulfonic acid as a catalyst are added to a beaker. The materials are stirred and warmed together rapidly forming a clear solution. Next, 1 mole succinic anhydride is weighed out and added to the glycerol solution. The mixture is continuously heated and stirred while monitoring temperature and viscosity. The temperature is raised slowly so as to not to overheat. The mixture clears around 130-140° C. forming a clear, slightly straw-colored solution. Slight bubbling is observable in the 140-150° C. range. The temperature of the solution is adjusted to 150-155° C. Bubbling will increase in this temperature range within a couple minutes. The solution is heated and stirred in this temperature range until a desired viscosity of 1-2 Poise is reached which takes anywhere from 60-120 minutes. The material should pour easily within the viscosity range noted and will be clear and straw-colored.

### Example 6

### Preparation of Glycerol-Adipate Oligomer

One mole glycerol and 0.50%, by weight of starting materials, methanesulfonic acid as a catalyst are added to a beaker. These materials are stirred and warmed together rapidly forming a clear solution. Next, weigh out 1 mole adipic acid and add it to the glycerol solution. Continue to heat and stir this mixture while monitoring temperature and viscosity. Raise the temperature slowly so as to not to overheat. Mixture clears around 100-110° C. forming a clear, slightly yellow-colored solution. Bubbling was noticeable, initially, in the 110-120° C. range. Adjust temperature to the 150-155° C. range. Bubbling will become moderate at this temperature after a few minutes. Continue to heat and stir the solution in this temperature range until reach desired viscosity, generally 1-5 Poise, which takes anywhere from 60-120 minutes. The material should still pour easily within the viscosity range noted and will be clear and slightly yellow-colored.

### Example 7

### Coating Substrates with Glycerol-Maleate Oligomer and Convection Oven Cure

Warm the glycerol-maleate of Example 1 to 80-100° C. to make it fluid enough to flow easily. Next, obtain a wood substrate to be coated and ensure its surface is clean. While the glycerol-maleate is still fluid, use a paint brush to uniformly spread a thin layer of the oligomer onto its surface. This thin layer of glycerol-maleate material is still fluid while it is warm and still tacky/sticky even when cool. To fully cure this layer of glycerol-maleate oligomer, place the coated wood sample in a convection oven for 3-60 minutes at 110-150° C.

### Example 8

### Coating Substrates with Glycerol-Citrate Oligomer and Convection Oven Cure

Warm the glycerol-citrate of Example 4 to 80-100° C. to make it fluid enough to flow easily. Next, obtain a glass substrate to be coated and ensure that its surface is clean. While the glycerol-citrate is still fluid, use a paint brush to uniformly spread a thin layer of the oligomer onto the surface of the glass substrate. This thin layer of material is fluid while it is warm and tacky/sticky even when cool. To fully cure this layer of glycerol-citrate oligomer, place the coated glass sample in a convection oven for 3-60 minutes at 110-150° C.

### Example 9

### Coating Substrates with Glycerol-Succinate Oligomer and Convection Oven Cure

Warm the glycerol-succinate oligomer of Example 5 to 80-100° C. to make it fluid enough to flow easily. Next, obtain the metal substrate to be coated and ensure that its surface is clean. While the glycerol-succinate is still fluid, use a paint brush to uniformly spread a thin layer of the oligomer onto the surface of the metal substrate. This thin layer of material is fluid while it is warm and tacky/sticky even when cool. To fully cure this layer of glycerol-succinate oligomer, place the coated metal sample in a convection oven for 3-60 minutes at 110-150° C.

### Example 10

### Coating Substrates with Glycerol-Adipate Oligomer and Convection Oven Cure

Warm the glycerol-adipate of Example 6 to 80-100° C. to make it fluid enough to flow easily. Next, obtain a wood substrate and ensure its surface is clean. While the glycerol-adipate is still fluid, use a paint brush to uniformly spread a thin layer of the oligomer onto the surface of the wood substrate. The thin layer of material is fluid while it is warm and tacky/sticky even when cool. To fully cure this layer of glycerol-adipate oligomer, place the coated wood sample in a convection oven for 3-60 minutes at 110-150° C.

### Example 11

### Coating Substrates with Glycerol-Maleate Oligomer and Microwave Oven Cure

Warm the glycerol-maleate of Example 1 to 80-110° C. to make it fluid enough to flow easily. Next, obtain a glass substrate and ensure its surface is clean. While the glycerol-maleate is still fluid, use a paint brush to uniformly spread a thin layer of the oligomer onto the surface of the glass substrate. This thin layer of material is fluid while it is warm and tacky/sticky even when cool. To fully cure this layer of glycerol-maleate oligomer, place the coated glass sample in a microwave oven for 1-10 minutes at 100-1000 watts.

### Example 12

### Coating Substrates with Glycerol-Maleate Oligomer and Dry Steam Cure

Warm the glycerol-maleate of Example 1 to 80-100° C. to make it fluid enough to flow easily. Next, obtain a metal substrate and ensure its surface is clean. While the glycerol-maleate is still fluid, use a paint brush to uniformly spread a thin layer of the oligomer onto the surface of the metal substrate. This thin layer of material is fluid while it is warm and tacky/sticky even when cool. To fully cure this layer of glycerol-maleate oligomer, place the coated metal sample in a stream of dry steam for 0.5-10 minutes at 110-300° C.

### Example 13

### Spray Coating Substrates with Glycerol-Maleate Oligomer and Convection Oven Cure

Warm the glycerol-maleate of Example 1 to 80-110° C. to make it fluid enough to flow easily. Next, obtain a wood substrate and ensure its surface is clean. While the glycerol-maleate is still fluid, spray a thin layer of the oligomer onto a surface of the wood substrate. This thin layer of material is fluid while it is warm and tacky/sticky even when cool. To fully cure this layer of glycerol-maleate oligomer, place the coated wood sample in a convection oven for 3-60 minutes at 110-150° C.

### Example 14

### Gravure Coating Substrates with Glycerol-Maleate Oligomer and Convection Oven Cure

Warm the glycerol-maleate of Example 1 to 80-100° C. to make it fluid enough to flow easily. Next, obtain a glass substrate and ensure that its surface is clean. While the glycerol-maleate oligomer is fluid, use a gravure coating process to apply the oligomer to the substrate by way of an engraved roller running through a bath of the fluid material filling in the engraved dots or lines of the roller with the coating material. The excess coating on the roller is wiped off by a doctor blade and the coating is then deposited onto the substrate as it passes between the engraved roller and a pressure roller. This thin layer of material is fluid while it is warm and tacky/sticky even when cool. To fully cure this layer of glycerol-maleate oligomer, place the coated glass sample in a convection oven for 3-60 minutes at 110-150° C.

### Example 15

### Extrusion Coating Substrates with Glycerol-Maleate Oligomer and Convection Oven Cure

Warm the glycerol-maleate Example 1 to 80-100° C. to make it fluid enough to flow easily. Next, obtain the metal substrate and ensure that its surface is clean. While the glycerol-maleate oligomer is fluid, squeeze the coating out by gravity or under pressure through a slot and onto the substrate on a moving belt or line. The belt or line speed can be adjusted so that is faster or slower than the speed of the extrusion of the glycerol-maleate oligomer coating as a way to control the thickness of the material applied. This will enable coatings to be considerably thinner or thicker than the width of the slot. This thin layer of material is fluid while it is warm and tacky/sticky even when cool. To fully cure this layer of glycerol-maleate oligomer, place the coated metal sample in a convection oven for 3-60 minutes at 110-150° C.

### Example 16

### ‘Knife Over Roll Coating Substrates with Glycerol-Maleate Oligomer and Convection Oven Cure

Warm the glycerol-maleate oligomer of Example 1 to 80-100° C. to make it fluid enough to flow easily. Next, obtain a wood substrate and ensure that its surface is clean. While the glycerol-maleate oligomer is fluid, apply the material to the surface of the wood substrate, which is situated on a moving belt or line, then pass it through a ‘gap’ between a ‘knife’ and a support roller. As the coating and substrate pass through, excess oligomer is scraped off. This layer of material is fluid while it is warm and tacky/sticky even when cool. To fully cure this layer of glycerol-maleate oligomer, place the coated wood sample in a convection oven for 3-60 minutes at 110-150° C.

### Example 17

### Preparation of Glycerol-Maleate Oligomer Suspension in Water

Warm the glycerol-maleate oligomer of Example 1 to 80-100° C. to make it fluid enough to flow. Add 5-40 g of the fluid glycerol-maleate oligomer and 40 g of water to a beaker. Disperse this mixture using a high speed rotor-stator dispersing tool operated for 30 seconds. This process yields a milky white suspension.

### Example 18

### Preparation of Glycerol-Succinate Oligomer Suspension in Water

Warm the glycerol-succinate oligomer prepared according to Example 5 to 80-100° C. to make it fluid enough to flow easily. Add 5-40 g of the fluid glycerol-succinate oligomer and 40g of water to a beaker. Disperse this mixture using a high speed rotor-stator dispersing tool operated for 30 seconds. This process yields a milky white suspension.

### Example 19

### Preparation of Glycerol-Adipate Oligomer Suspension in Water

Warm the glycerol-adipate oligomer prepared according to Example 6 to 80-100° C. to make it fluid enough to flow easily. Add 5-40 g of the fluid glycerol-adipate oligomer and 40 g of water to a beaker. Disperse this mixture using a high speed rotor-stator dispersing tool operated for 30 seconds. This process yields a milky white suspension.

### Example 20

### Coating Substrates with Glycerol-Maleate Oligomer Suspension in Water and Convection Oven Cure

Obtain a metal substrate and ensure its surface is clean. Using a paintbrush uniformly spread a thin layer of the glycerol-maleate oligomer suspension in water prepared according to Example 17 onto the surface of the metal substrate. This thin layer of material is tacky/sticky even when all the water has evaporated. To fully cure this layer of glycerol-maleate oligomer, place the coated metal sample in a convection oven for 3-60 minutes at 110-150° C.

### Example 21

### Coating Substrates with Glycerol-Succinate Oligomer Suspension in Water and Convection Oven Cure

Obtain a wood substrate and ensure its surface is clean. Using a paintbrush uniformly spread a thin layer of the glycerol-succinate oligomer suspension in water prepared according to Example 18 onto the surface of the wood substrate. This thin layer of material is tacky/sticky even when all the water has evaporated. To fully cure this layer of glycerol-succinate oligomer, place the coated wood sample in a convection oven for 3-60 minutes at 110-150° C.

### Example 22

### Coating Substrates with Glycerol-Adipate Oligomer Suspension in Water and Convection Oven Cure

Obtain the glass substrate and ensure that its surface is clean. Using a paintbrush uniformly spread a thin layer of the glycerol-adipate oligomer suspension in water prepared according to Example 19 onto the surface of the glass substrate. This thin layer of material is tacky/sticky even when all the water has evaporated. To fully cure this layer of glycerol-adipate oligomer, place the coated glass sample in a convection oven for 3-60 minutes at 110-150° C.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of coating a surface of a substrate comprising the steps of:
(a) providing a substrate;
(b) providing coating precursor comprising a reactive mixture, the reactive mixture selected from the group consisting of:
1) at least one polyhydric alcohol and reactant selected from the group consisting of: at least one organic polyacid, at least one organic anhydride; and combinations thereof;
2) a pre-polymer formed from a reactive mixture according to (1);
3) combinations of the reactive mixture in (1) and the pre-polymer in (2); and
4) combinations of the pre-polymer in (2) and reactants selected from the group consisting of: polyhydric alcohol, organic polyacid, organic anhydride; and combinations thereof;
(c) applying the coating precursor to a surface of the substrate; and
(e) reacting, the coating precursor to form a coating on the surface of the substrate as a product of ester condensation.

2. The method according to claim 1, wherein the polyhydric alcohol is selected from the group consisting of glycerol, glycol and combinations thereof.

3. The method according to claim 1, wherein the organic polyacid is selected from the group consisting of adipic acid, citric acid, maleic acid, succinic acid, polyacrylic acid and combinations thereof.

4. The method according to claim 1, wherein the anhydride is selected from the group consisting of succinic anhydride, maleic anhydride, phthalic anhydride and combinations thereof.

5. The method according to claim 1, wherein the reactive mixture further comprises monobasic acid, monoglyceride, diglyceride, or triglyceride.

6. The method according to claim 1, wherein the reactive mixture further comprises compounds having functional groups selected from the group consisting of acid groups, alcohol groups and combinations thereof, and further wherein the compounds are selected from the group consisting of oligomeric silicone, polyethylene glycol and combinations thereof.

7. The method according to claim 1, wherein the substrate is selected from the group consisting of wood, glass, nonwoven, paper and cardboard.

8. A composite structure comprising a substrate and a coating precursor deposited on the surface of the substrate, wherein the coating precursor comprises a reactive mixture selected from the group consisting of:
a) at least one polyhydric alcohol and reactant selected from the group consisting of: at least one organic polyacid; at least one organic anhydride; and combinations thereof;
b) a pre-polymer formed from a reactive mixture according to (a);
c) combinations of the reactive mixture in (a) and the pre-polymer in (b); and
d) combinations of the pre-polymer in (b) and reactants selected from the group consisting of: polyhydric alcohol; organic polyacid; organic anhydride; and combinations thereof;
wherein the reactive mixture is reacted to change the coating precursor to a solid coating as a product of ester condensation.

9. The composite structure according to claim 8, wherein the polyhydric alcohol is selected from the group consisting of glycerol, glycol and combinations thereof.

10. The composite structure according to claim 8, wherein the organic polyacid is selected from the group consisting of adipic acid, citric acid, maleic acid, succinic acid polyacrylic acid and combinations thereof.

11. The composite structure according to claim 8, wherein the anhydride is selected from the group consisting of succinic anhydride, maleic; anhydride, phthalic anhydride and combrinations thereof.

12. The composite structure according to claim 8, wherein the reactive mixture further comprises monobasic acid, monoglyceride, diglyceride, or triglyceride.

13. The composite structure according to claim 8, wherein the reactive mixture further comprises compounds having functional groups selected from the group consisting of acid groups, alcohol groups and combinations thereof, and further wherein the compounds are selected from the group consisting of oligomeric silicone. polyethylene glycol and combinations thereof.

14. The composite structure according to claim 8 wherein the substrate is selected from the group consisting of wood, glass, nonwovens, paper and cardboard.

15. A composite structure comprising a substrate and a coating precursor deposited at select locations on a surface of the substrate, the coating precursor comprising a reactive mixture selected from the group consisting of:
a) at least one polyhydric alcohol and reactant selected from the group consisting of:
at least one organic polyacid; at least one organic anhydride; and combinations thereof;
b) pre-polymer formed from a reactive mixture according to (a);
c) combinations of the reactive mixture in (a) and the pre-polymer in (b); and
d) combinations of the pre-polymer in (b) and reactants selected from the group consisting of: polyhydric-alcohol, organic polyacid; organic anhydrides and combinations thereof;
wherein the reactive mixture is reacted to change the coating precursor to a solid coating as a product of ester condensation providing selective reinforcement to the substrate.

16. The composite structure according to claim 15, wherein the polyhydric alcohol is selected from the group consisting of glycerol, glycol and combinations thereof.

17. The composite structure according to claim 15, wherein the organic polyacid is selected from the group consisting of adipic acid, citric acid, maleic acid, succinic acid, polyacrylic acid and combinations thereof.

18. The substrate according to claim 15, wherein the anhydride is selected from the group consisting of succinic anhydride, maleic anhydride, phthalic anhydride and combinations thereof.

19. A method of selectively reinforcing the surface of a substrate comprising the steps of:
(a) providing a reactive mixture selected from the group consisting of:
1. at least one polyhydric alcohol and reactant selected from the group consisting of: at least one organic polyacid, at least one organic anhydride; and combinations thereof;
2. pre-polymer formed from a reactive mixture according to (1);
3. combinations of the reactive mixture in (1) and the pre-polymer in (2); and
4. combinations of the pre-polymer in (2) and reactants selected from the group consisting of: polyhydric alcohol in (2) and reactants selected from the group combinations thereof;
(b) applying the reactive mixture to a surface of the substrate in selective locations as a coating precursor; and
(c) reacting the reactive mixture to solidify the coating precursor as a product of ester condensation providing selective reinforcement of the substrate.

20. The method according to claim 19, wherein the substrate is selected from the group consisting of nonwoven, paper and cardboard.
